(19) United States
(12) Patent Application Publication
(10) Pub. No.: US 2003/0159298 A1
(43) Pub. Date: Aug. 28, 2003

(54) Automotive wheelless alignment device with sensor head

(76) Inventor: James A. Mieling, Batavia, IL (US)

Correspondence Address: Jefferson Perkins, Piper Marbury Rudnick & Wolfe, Suite 1800, 203 North LaSalle Street, Chicago, IL, 60601-1293, US

(21) Appl. No.: 09/973,598

(22) Filed: Oct. 9, 2001

(51) Int. Cl. G01B 5/24

(52) U.S. Cl. 33/203.15

(57) ABSTRACT

A wheelless alignment device for a multiple-wheeled vehicle, wherein each of the wheels bears a portion of the vehicle's weight, has a rigid support member affixable to a wheel hub after its wheel has been removed. The rigid support member bears the portion of the weight of the vehicle normally borne by the removed wheel without substantial deformation, and has at least three reference surfaces that mate with corresponding reference surfaces of a sensor head frame. The reference surfaces are in spaced nonlinear relationship to each other. At least one affixation member attaches the head frame to the rigid support member at locations spaced from the registered reference surfaces, so that after registration the spatial relationship between the wheel hub and the sensor head is unchanged by variances in tightening. This arrangement produces greater accuracy in wheel alignment measurement and adjustment.

### TECHNICAL FIELD OF THE INVENTION

The present invention relates in general to wheel alignment devices. More particularly, the present invention relates to a device for the wheelless alignment of a vehicle having multiple, load-bearing wheels, at least one of which is removable from a wheel hub, the device incorporating a video camera target or an electronic sensor head.

### BACKGROUND

The alignment of the wheels on automobiles, trucks, and like, conventional multiple-wheeled vehicles is necessary to optimize steering and handling characteristics and to prolong tire life. The most common devices and systems for accomplishing this try to do so with the wheels being left on the vehicle. “Wheels-on” alignment is laborious and time-consumptive, as the points on the wheel strut assembly which the mechanic adjusts are difficult to reach and are occluded by the tire and wheel. Wheels-on alignment continues to be the dominant method of wheel alignment because for an accurate wheel alignment, it is necessary for the wheel hub and associated strut assembly to bear that portion of the vehicle weight that that wheel usually bears. Wheels-on alignment accomplishes this by the straightforward but inconvenient expedient of having the tire and wheel bear the usual load.

The inventor advanced an alternative method, wheelless alignment, by introducing apparatus and methods which permitted the adjustment of caster, camber and toe without the necessity of having the wheels on the vehicle. This made access to the adjustment points much easier and the alignment much speedier to accomplish. For example, the inventor's U.S. Pat. No. 5,842,281 discloses a rigid support member attachable to the wheel hub for bearing that portion of the vehicle weight that that wheel usually bears. The rigid support member in turn is mounted on a turntable which permits turning the support member, and therefore the wheel hub to which it is mounted, during the wheel alignment process. Various nonelectronic gauges and devices, such as those disclosed in the inventor's U.S. Pat. No. 5,471,754, can be attached to the rigid support member for measurement. The contents of U.S. Pat. Nos. 5,471,754 and 5,842,281 are hereby incorporated by reference as if fully set forth herein.

A relatively recent trend has been to use an electronic sensor head, or, alternatively, a video camera visual target, mounted to each vehicle wheel to perform the alignment measurements in conjunction with a computer usually located nearby. These electronic sensor heads or video camera targets (hereinafter generically referred to as “sensor heads”) are conventionally mounted to respective ones of the wheel rims by using a claw-like member which clamps, at two diametrically opposed locations, onto the lip of the wheel rim.

The use of the claw-like mounting member is problematic in several respects. First, it is difficult to mount the claw member to the wheel rim. Second, the clamping force exerted on the lip of the wheel rim, and the tensioning force tending to draw opposing sides of the wheel rim together, is arbitrarily set by the mechanic attaching the sensor head, and variably deforms the wheel rim in such a manner that the sensor head measurements are distorted. Relatedly the sensor head frame members spanning the attachment points will have a tendency to bow to a degree that varies with the force with which the frame is attached to the wheel rim, again causing a displacement in sensor head position. Third, it is difficult to ensure repeatability of measurements since it is practically impossible to ensure that the claw is attached to precisely the same location on the wheel rim, with precisely the same tensioning and clamping force, each time. As vehicles become lighter, the wheel rims supporting them do not need to be as substantial, and the danger of measurement-distorting deflection or deformation of the wheel rims increases. And because this claw is typically used in a wheels-on system, all of the problems and time consumption of a wheels-on wheel alignment persist.

Previously it has been proposed to attach such sensor heads, and the claw-like attachment members with which they are provided, to wheel rim analogs formed on the support members of a wheelless alignment system. But inaccuracy and imprecision problems persist, because the site at which the claw-like assembly is attached is the same as the site at which clamping and tensioning force is exerted, and various degrees of bowing or warping of the spanning sensor head attachment frame members will result. The act of attachment of the sensor head therefore continues to create measurement inaccuracy and lack of repeatability. Recalibration, or “runout”, must be done every time the sensor head frame is reattached to a wheel rim or to an analog of same. Wheel alignments on late model vehicles require accuracy to within thousandths of an inch, but unfortunately conventional alignment apparatus mounting practices produce errors of the same order of magnitude. Conventional sensor head attachment methods use vertical bars upon which the sensor head slides. These vertical bars impose additional impediments to vision and access when attempting to make alignment adjustments.

It would therefore be desirable to have a wheelless alignment device which includes provision for mounting a sensor head in precise and repeatable spatial relation to the wheel hub to which the sensor head is physically coupled, which would provide optimum visual and physical access to the adjustment points by the mechanic, and which would permit the easy integration of a wheelless alignment system with computer-aided calibration.

### SUMMARY OF THE INVENTION

The above and further technical advantages of the present invention are realized by providing a new and improved wheelless alignment device, and a method for using same, for a vehicle with multiple wheels each bearing a portion of the weight of the vehicle, wherein at least one of the wheels is removable from a respective wheel hub. According to one aspect of the invention, a wheelless alignment device includes a rigid support member that is affixed to the wheel hub, either directly or by means such as an adapter plate, so as to bear that portion of the weight of the vehicle usually borne by the removed wheel. Preferably the rigid support member is sufficiently robust that this vehicle weight portion will cause substantially no deformation of the rigid support member. At least one support member reference surface is defined on the rigid support member.

A sensor head frame includes at least one head frame reference surface meant to be placed in registration with the respective support member reference surface. An attachment member or device is mounted to the rigid support member so as to be spaced away from the rigid support member reference surface in such a way that the act of attachment does not cause any substantial deflection of the sensor head. Therefore, no spatial relationship error can be introduced by any mechanic-induced variation of force to by which the sensor head frame is attached to the rigid support member. Preferably the attachment member is so disposed that the act of its attachment will not warp or deflect the sensor head frame, and therefore the sensor head may be accurately and repeatably affixed to the rigid support member so that its position in three-dimensional space relative to the rigid support member, and therefore relative to the wheel hub, does not change.

In a preferred embodiment, the rigid support member reference surface is formed by the bottom of a bore in the rigid member, and the sensor head frame reference surface is formed by the end of a pin adaptable to be received in the bore. The attachment member or device may include a screw, itself threadedly received in a second bore spaced from the rigid member reference surface and formed at an angle to the first bore, which clamps the pin into place. Because the screw is spaced from the mating reference surfaces and because the act of clamping does not deflect or bend the pin, the position of the sensor head attached to the frame is substantially impervious to mechanic-induced variations in screw-tightening force.

In another aspect of the invention, the rigid member of the wheelless alignment device has at least three, and preferably four, such reference surfaces, and the sensor head frame has at least three and preferably four mating reference surfaces. The rigid member reference surfaces and the mating ones of the frame reference surfaces are spaced apart in nonlinear relationship to each other, so as to define a three-dimensional frame of reference. The rigid member reference surfaces can be the bottoms of spaced-apart bores having parallel axes and the sensor head frame reference surfaces can be the ends of respective pins adaptable to be received in those bores. The use of at least three sets of such reference surfaces provides further dimensional stability and further mitigates any warping or deflection which could displace the sensor head. At least one affixation member affixes the sensor head frame to the rigid support member such that the head frame reference surfaces will be in registry with the rigid support member reference surfaces, thereby resulting in precise and repeatable spatial disposition of the sensor head relative to the wheel hub.

The present invention thus provides repeatability in measurement not attained in prior art computer-aided wheel alignment devices; “runout” or zeroing of the instrument will need to be done at a frequency of each day or less, instead of each time a sensor head is mounted to an automobile wheel rim. Further, the preferred form of the sensor head frame is such that interference with the mechanic's ability to see and get access to the adjustment points is minimized.

### BRIEF DESCRIPTION OF THE DRAWINGS

The above and other aspects of the invention and their technical advantages will become apparent, by referring to the following detailed description of the invention in conjunction with the accompanying drawings, wherein:

FIG. 1 is an exploded isometric view of portions of a wheelless alignment device constructed in accordance with the present invention;

FIG. 2 is an isometric view of the wheelless alignment device shown in FIG. 1, showing further components and their assembly to a vehicle wheel hub to be aligned;

FIG. 3 is an exploded isometric view of the rigid support member, turntable and wheel hub adapter plate of the embodiment illustrated in FIGS. 1 and 2;

FIG. 4 is a front view of a sensor head frame according to the invention, the sensor head being removed for purposes of clarity;

FIG. 5 is a cross-sectional side view of the sensor head frame as mounted to the rigid support member;

FIG. 5a is a detail of FIG. 5 showing bore, pin and reinforcing ring construction;

FIG. 6 is a front elevational view of a rigid support member according to the invention;

FIG. 7 is a cross-sectional side view of an alternative embodiment of a sensor head frame according to the invention;

FIG. 8a is an elevational view of a workpiece used to make a back plate according to the invention; and

FIG. 8b is a top view of the back plate of FIG. 8a after a bending operation.

### DETAILED DESCRIPTION OF ILLUSTRATED EMBODIMENTS

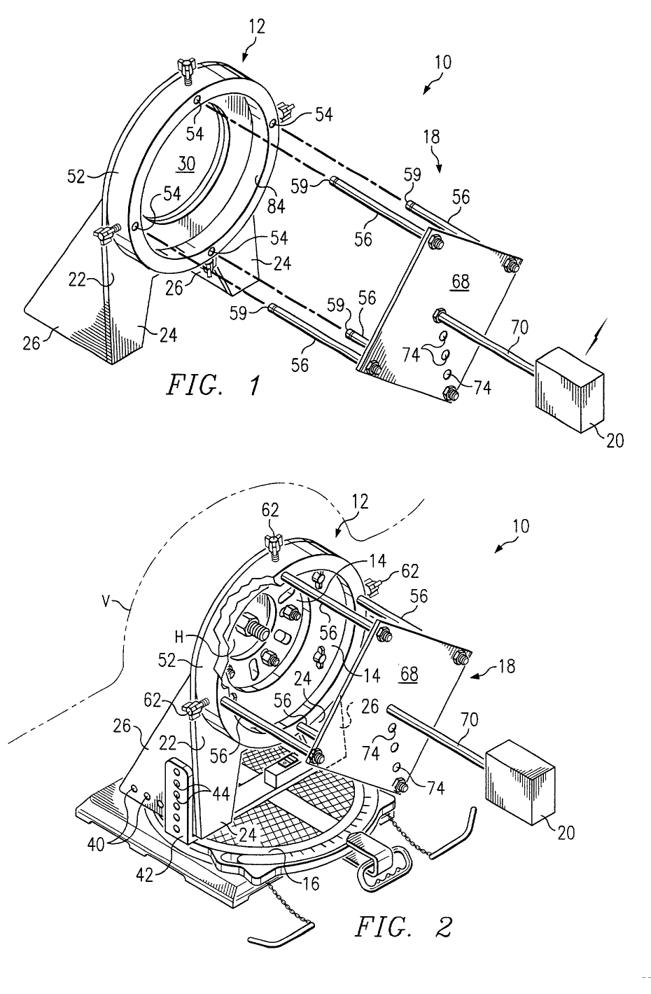

Referring first to FIGS. 1-3, a wheelless alignment device indicated generally at 10 permits a “wheels-off” alignment of a load-bearing vehicle wheel. A wheel well of vehicle V is illustrated in dashed line in FIG. 2. Vehicle V will usually have at least four load-bearing wheels and at least the steering ones of these require alignment by adjusting the camber, caster and toe of the wheel. These adjustment points are positioned at places on a strut assembly (not shown) that are typically behind the vehicle wheel, making access to those adjustment points difficult, because for proper alignment and according to traditional practice, the wheel is left on the vehicle and supports a portion of the weight of the vehicle.

To solve this problem the present invention uses a “wheels-off” alignment device 10 which supports that portion of the vehicle weight normally supported by the removed wheel, but which may be rotated and which permits far easier access to the caster, camber and toe adjustment points on the strut assembly. The vehicle wheel rim and tire (not shown) are removed, exposing the wheel hub H that is suspended by the wheel strut assembly (not shown).

The principal components of device 10 are a rigid support member 12, an adapter plate 14 by which, in the illustrated embodiment, the support member 12 is affixed to the hub H of a vehicle V of a particular make (alternatively, the adapter plate 14 can be integrated with the rigid support member 12), a turntable 16 which supports the rigid support member 12 and its load, and permits it to turn in concert with the wheel hub to which it is affixed, and a sensor head frame 18 that includes a sensor head 20, which may be an electronic transmitter, a visual target or another type. The sensor head may, for example, be the DSP400 manufactured by Hunter Engineering Company. The rigid support member 12 is termed “rigid” because it should be stout enough to bear that portion of the weight of the vehicle V normally borne by the removed wheel without substantial deflection or deformation; for automobiles and light trucks, and for front wheels which typically bear disproportionately more of the engine weight, this weight is typically on the order of 1000 to 2000 pounds. Rigid support member 12 is conveniently constructed of steel.

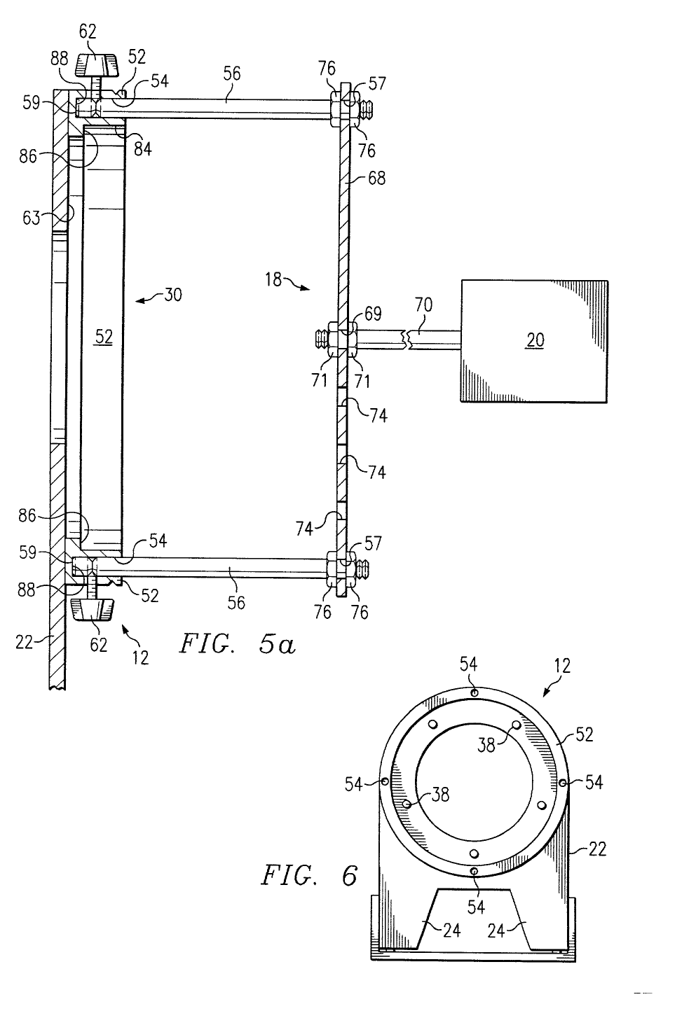

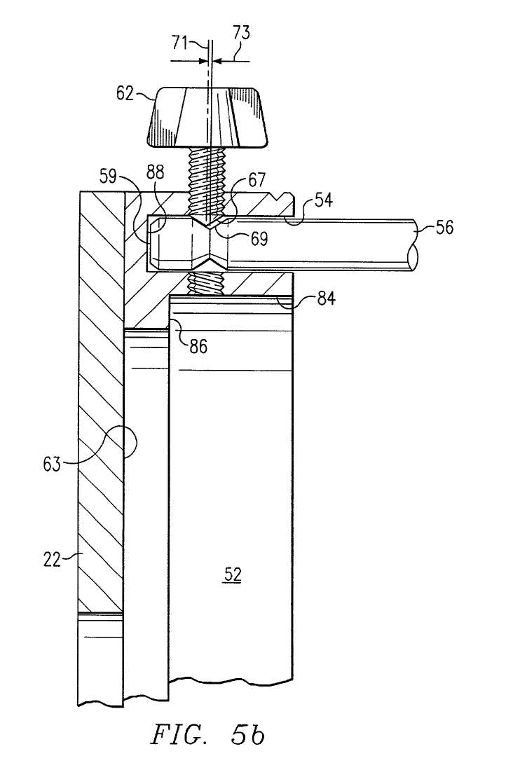

The support member 12 can be constructed around a substantially vertically disposed back plate 22, which in the illustrated embodiment is ¼ inch thick and fabricated of steel. FIGS. 8a and 8b show back plate 22 at two stages of fabrication. Back plate 22 includes a pair of spaced-apart support legs 24. Legs 24 have a pair of wings which are folded back (FIG. 8b) to create triangular support legs 26. The back plate 22 is formed around a central opening 30 which in use is coaxial with the wheel hub. In the illustrated embodiment, holes 80 are used to plug-weld the back plate 22 to the reinforcing ring 52 (FIGS. 5, 5a). Locations 82 mark the placement of bolts or studs 38 for the affixation of the adapter plate 14 (see FIG. 3).

Referring to FIG. 3, preferably, the adapter plate 14, which should be as resistant to deformation as the rigid support member 12 since a portion of the vehicle weight will be transmitted through it, is releasably coupled to the rigid support member 12 as by a plurality of bolts 38 and nuts 39 to facilitate easy replacement of the rigid adapter plate 14.

With reference for example to FIG. 2, each triangular plate or leg flange 26 includes a plurality of mounting holes 40 for selectively mounting the leg 24, 26 to a position adjustment assembly 42 of the turntable 16, the assembly 42 also including a plurality of mounting holes 44. More particularly, each support leg 24 is selectively coupled to the position adjustment assembly 42 by a coupling pin 46 or the like inserted into corresponding ones of the mounting holes 40, 44.

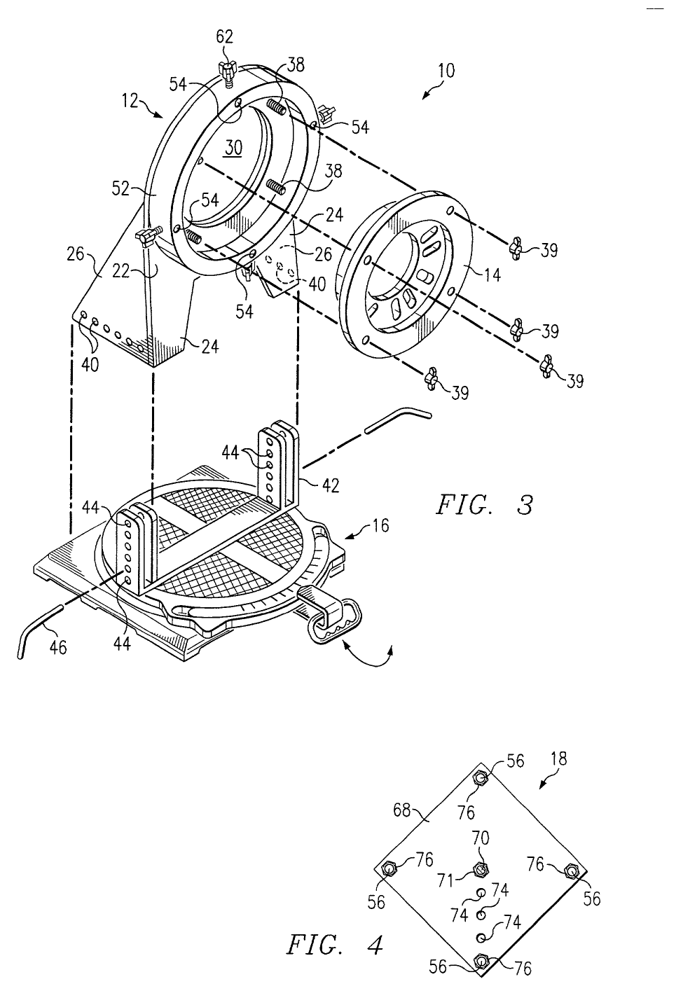

As best seen in FIG. 4, the sensor head frame 18 is, in one embodiment, conveniently fabricated using a relatively rigid flat plate or body 68. Plate 68 may be of any convenient shape and has a height and width sufficient to hold a plurality of mounting pins 56 in respective bores 57 (FIG. 5). Mounting pins 56 may be held to plate 68 by threading their proximal ends and using nuts 76 on either side of the thickness of plate 68, or they may be affixed by welding. Mounting pins 56 should be long enough to be inserted into bores formed in the rigid member 12 (as will be explained below) and still provide enough standoff from the central region of the rigid member 12 that the plate 68 will not get in the way of any protruding portions of the vehicle hub H or of other elements of the wheelless alignment apparatus. In the illustrated embodiment the pins 56 are about seven inches long. A central bore 69 receives a sensor head mounting rod or boom 70 and in the illustrated embodiment is similarly affixed to the plate 68 by nuts 71. In use the central bore 69 and boom 70 are usually mounted to be coaxial with the axis of the wheel hub; however, there will be situations in which target or sensor head 20 must be positioned lower than the wheel hub axes in order to have a clear line of sight to the other sensor heads and/or the central alignment computer (not shown). In this instance one of the several alternative sensor boom mounting holes (there are three such in the illustrated embodiment) 74 is used.

Each sensor head frame mounting pin 56 has a free end 59 that is a precise distance away from the plate 68; in the illustrated embodiment, there are four ends 59 that occupy a plane that is parallel to the plate 68. The ends 59 form a set of sensor head frame reference surfaces that are spaced apart in nonlinear relation to each other.

While four such reference surfaces 59 are shown and are provided as the free ends of parallel and circularly cylindrical pins 56, other means of providing spaced apart, noncolinear sensor head frame reference surfaces can be used. For example, one or more of the pins 56 may have a shape other than circularly cylindrical, the reference surfaces may be intentionally placed so as not to occupy a single plane, and as few as three or many more than four such reference surfaces may be used. One or more of the reference surfaces may even be integrated together, as long as portions of them are spaced from other portions of them in more than one direction so as to define a single orientation in three-dimensional space. Also, sensor head 20 may be affixed to the frame 18 in any convenient fashion; it is preferred that the head 20 protrude laterally outwardly to get a clear line of sight to the other heads 20 and/or the central computer or control video camera.

As best seen in FIGS. 5, 5a and 6, mounted as by welding to the front of the back plate 22 is a circular reinforcing ring 52. Ring 52 is conveniently formed of an annulus cut from a heavy-gauge steel pipe of 1¼ in.-thickness. In the illustrated embodiment an interior sidewall 84 of ring 52 is created by machining the original sidewall down by about ¼ in., to a depth (in a direction parallel to the wheel hub or head frame pin axes) of about 1 ⅝ in. This defines a shoulder 86 meant to receive the adapter plate 14 (FIG. 3). Horizontally extending bores 54 are drilled in the ring 52, matching in number and location the sensor head frame mounting pins 56. Bottoms 88 of the bores 54 form a set of disk-shaped rigid member reference surfaces. Thus, each end 59 of a head frame mounting pin registers with a bore bottom surface 88.

Bores 54 are only slightly (preferably, 5/1000in.) larger than the diameter of pins 56; bores 54 should only be so much larger than the pins 56 that the pins 56 will slide into them without binding. In this way, precise, three-dimensional registration of the sensor head frame 18 with the rigid member 12 can be achieved, and this in turn means that the positioning of the sensor head frame 18 (and therefore the sensor head 20) will be fixed with precision relative to the wheel hub H. The sidewalls of bores 54, acting to restrict the positioning of the respective pins 56, prevent the pins' bending or flexing even at their junctures with sensor head frame plate 68, thereby further rigidifying the physical position of the sensor head 20.

Preferably, the reinforcing ring 52 also forms a portion of an affixation member or device which releasably affixes the pins 56 within the bores 54. In the illustrated embodiment this is done by way of screws 62 which are respectively and threadedly received in screw holes 60. The screw holes 60 open onto bores 54 and their axes intersect and are at an angle (such as 90°) to respective axes of bores 54. Hence, once the pins 56 are received in bores 54 such that their end surfaces 59 are in complete registration with surfaces 88, the screws 62 are tightened to fix the mounting pins in position. Note that the points of affixation are displaced away from the sites of the mating reference surfaces, and note further that the amount of force exerted in tightening the screws 62 against the pins 56 will produce no bending or warping of the pins 56 or of plates 22 or 68. Alternatively, other forms or sites of affixation may be used, with the proviso that they do not produce any bending or deflection of the mounting pins 56. For example, keyways in pins 56 and keys could be used instead of the pressure screws 62. In another embodiment, bores 54 may be drilled all the way through the reinforcing ring 52, such that a front surface 63 of back plate 22 takes the place of registration surfaces 88.

In a preferred embodiment, each of the screws 62 terminates in a conical surface 67 and each of the pins 56 has a V-shaped circumferential groove 69 positioned such that, when an end 59 of the pin 56 is in registration with the respective surface 88, the conical surface 67 of the respective mounting screw contacts the groove 69. This lends further precision to the spatial relationship between the rigid member 12 and the sensor head frame 18. Even more preferably, the axis 71 of each screw 62 is slightly closer to surface 88 than the distance 73 of the bottom of groove 69 thereto when the pin end 59 abuts surface 88. As screw 62 is tightened, the terminal conical surface 67 of screw 62 slides downward against the distal inclined surface of the groove 69. Groove 69 will be urged leftwardly under the influence of screw surface 67. This makes sure that, upon tightening of screw 62, the shaft of pin 56 will be forced as far toward surface 88 as is possible, ensuring the complete registration of pin end 59 with surface 88. In place of the conical and V-shaped surfaces shown, other convex rotational surfaces of screw 62, and other concave, local or circumferential shapes in pin 56, can be used.

Because the sensor head frame has a relatively small “footprint” in comparison to prior art vertical sensor head wheel rim attachment bars, the mechanic is able to more easily see and gain access to the adjustment points on the wheel strut assembly.

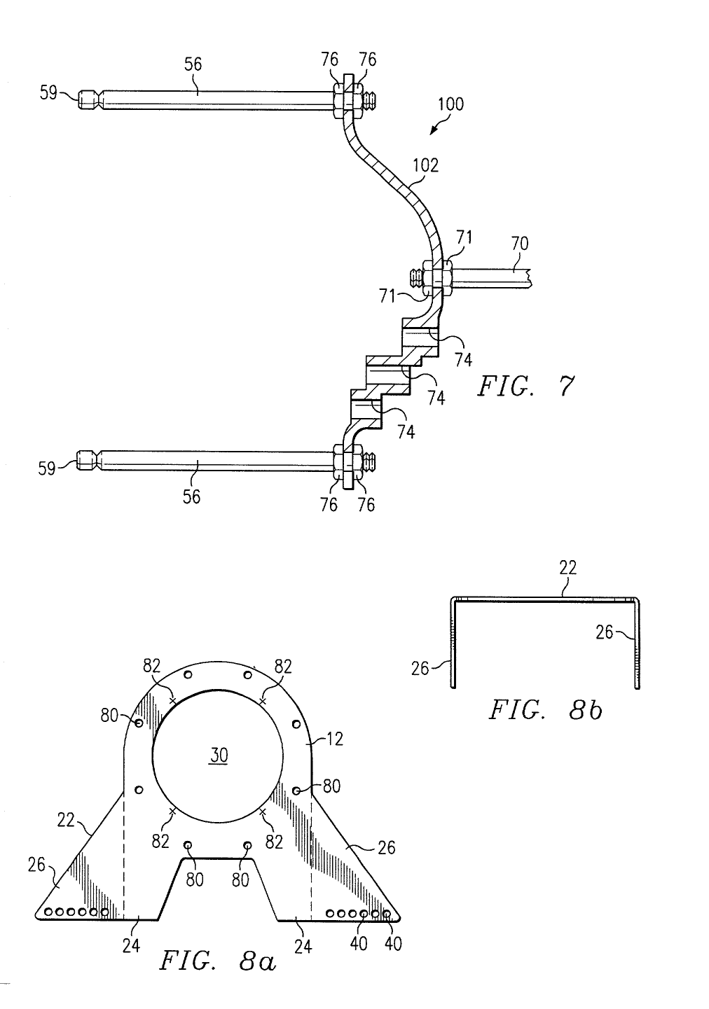

FIG. 7 shows an alternative embodiment of a sensor head frame according to the invention. The head frame 100 continues to have pins 56 with end surfaces 59, and these will register with the surfaces 88 of the reinforcing ring 52 of the rigid member 12, as before. But the head frame 100 replaces the flat plate as seen in FIG. 1 with an outwardly convex plate 102. A central boom 70 is provided as before for a sensor head (not shown). The advantages of the embodiment shown in FIG. 7 are that such a bowl-shaped plate 102 will be inherently rigid, and more accommodation is made for any protruding portion of hub H, which for example may be encountered in certain light trucks. Other shapes for the sensor head frame, particularly those which more easily accommodate protruding hub portions, may be thought of, such as conical, frustoconical, cylindrical, pyramidal or box-like shapes.

In operation, the vehicle is jacked up and two or four wheels are removed from their wheel hubs. For each removed wheel, a rigid support member/adapter plate combination is prepared by selecting an adapter plate 14 that is compatible with the stud pattern of the wheel hub H (FIG. 2). The adapter plate is then affixed to the rigid member 12 and the plate 14 and member 12 are bolted to the wheel hub H. A turntable 16 is placed under the rigid member 12 and joined to it by pinning a selected combination of hole pairs 40, 44. The sensor head frame is mounted either before or after this to the rigid member 12 by inserting the ends 59 of mounting pins 56 into the bores 54, taking care to completely register the ends 59 with the surfaces 88 of rigid member 12, as by tightening screws 62. The vehicle V is then jacked down such that a portion of its weight is borne by the apparatus and such that that weight portion loads the strut assembly of the wheel hub in question. The mechanic then makes his or her alignment adjustments, referring as necessary to a display of the alignment computer to make sure that the alignment comes into specification for that vehicle. The wheelless alignment system of the invention saves time over conventional techniques in that (a) “run outs” do not have to be performed for each vehicle, (b) it is easier for a mechanic to iteratively refer to a computer display and then make adjustments to the strut assembly adjustment points, making adjustments until the position of the wheel is within specified tolerances, and (c) in the instance where one or more of the tires are to be replaced, the alignment can take place while other workers are changing and balancing the tires on the wheels of the vehicle.

In summary, wheelless alignment apparatus has been illustrated and described that permits greater accuracy and precision in measurement of wheel hub position. This is accomplished by spatially and functionally separating the registration of reference surfaces of the sensor head frame with corresponding surfaces of the rigid support member from the means used to affix the sensor head frame to the rigid support member. Precision and repeatability of results are also aided by using the reference surfaces to define a position in three dimensions. The wheelless alignment apparatus is thus particularly well suited for use in computerized applications and with modem day vehicles, where alignment tolerances are often expressed in thousandths of an inch.

While particular embodiments of the present invention have been disclosed, it is to be understood that various different modifications are possible and are contemplated within the true spirit and scope of the appended claims.

What is claimed is:

1. A wheelless alignment device for a vehicle having a plurality of load-bearing wheels and wheel hubs upon which the wheels are removably mounted, comprising:
a rigid support member for supporting a portion of the weight of the vehicle normally borne by one of the load-bearing wheels, at least one support member reference surface formed by the rigid support member;
at least one sensor head frame attachment device coupled to the rigid support member to be spaced from the support member reference surface; and
a sensor head frame having at least one frame reference surface for mating with said at least one support member reference surface, the sensor head frame attachment device affixing the sensor head frame to the rigid support member in a predetermined position relative to the support member reference surface without substantial deflection of the sensor head.

2. The wheelless alignment device of claim 1, and further comprising:
a wheel hub adapter plate for affixation to a wheel hub of the vehicle, the wheel hub adapter plate removably mounted to the rigid support member.

3. The wheelless alignment device of claim 1, and further comprising:
a turntable coupled to the rigid support member and bearing said portion of the weight of the vehicle, the turntable permitting the rigid support member and an attached wheel hub to be rotated.

4. The wheelless alignment device of claim 1, wherein the rigid support member defines a plurality of support member reference surfaces spaced apart from each other, the electronic sensor head frame having a plurality of frame reference surfaces for registration with respective ones of the support member reference surfaces.

5. The wheelless alignment device of claim 4, wherein the support member reference surfaces are substantially disposed in a plane.

6. The wheelless alignment device of claim 4, wherein the rigid support member includes at least three support member reference surfaces disposed such that each support member reference surface is not colinear with the other two support member reference surfaces, and such that the support member reference surfaces together define a single orientation in three-dimensional space.

7. A wheelless alignment device for aligning a wheel in a multiwheeled vehicle, the vehicle having a plurality of load-bearing wheels each of which bear a portion of the weight of the vehicle, at least one of said wheels being removable from a wheel hub, the device comprising:
a rigid support member for affixation to a hub of one of said wheels after the respective wheel has been removed from the hub, said rigid support member adaptable to receive, without substantial physical deformation, that portion of the vehicle weight normally borne by the removed wheel;
at least three rigid member reference surfaces defined on the rigid member to be in spaced and nonlinear relation to each other;
a sensor head frame having at least three frame reference surfaces for respective registration with said at least three rigid member reference surfaces; and
at least one head frame affixation member for affixing the sensor head frame to the rigid support member such that each of the frame reference surfaces will be in registry with a respective one of the rigid member reference surfaces, affixation of the sensor head frame to the rigid support member by said at least one affixation member resulting in precise and repeatable spatial disposition of the sensor head relative to the wheel hub.

8. The wheelless alignment device of claim 7, wherein the rigid member is affixed to the wheel hub by means of an adapter plate.

9. The wheelless alignment device of claim 7, wherein said at least three head frame reference surfaces comprise free ends of respective pins of the sensor head frame.

10. The wheelless alignment device of claim 9, wherein the pins are disposed to be parallel to each other.

11. The wheelless alignment device of claim 9, wherein said at least three rigid support member reference surfaces comprise bottoms of bores in the rigid support member, each bore sized to closely receive one of said pins.

12. The wheelless alignment device of claim 11, wherein said at least one affixation member is one of a plurality of screws threaded into second bores which open on said bores at positions spaced from respective ones of said rigid member reference surfaces, said screws clamping the pins within the bores such that the ends of the pins are in registration with the rigid member reference surfaces.

13. The wheelless alignment device of claim 12, wherein each of said screws terminates in a convex rotational surface, each pin having a concave surface spaced from the reference surface such that the convex surfaces of the screws will mate with the concave surfaces on the respective pins.

14. The wheelless alignment device of claim 13, wherein the convex surfaces of the screws are cones.

15. The wheelless alignment device of claim 13, wherein the concave surfaces of the pins are circumferential grooves.

16. The wheelless alignment device of claim 15, wherein the grooves are V-shaped.

17. The wheelless alignment device of claim 13, wherein the concave surfaces of the pins are slightly farther away from the free ends thereof than the distance between the axes of the screws and the rigid member reference surfaces, such that clamping the convex surface of each screw against the concave surface of a respective pin forces the free end of the pin against the respective rigid member reference surface.

18. The wheelless alignment device of claim 12, wherein said second bores are generally orthogonal to respective ones of said bores.

19. The wheelless alignment device of claim 7, wherein there are at least four rigid member reference surfaces and at least four head frame reference surfaces.

20. A frame for mounting a sensor head to a rigid support member of a wheelless alignment device, comprising:
a body;
at least three mounting pins extending from the body in a first direction and disposed in spaced nonlinear relationship to each other, each of the pins being parallel to the others; and
a sensor mount extending from the body in a second direction opposed the first direction and adaptable to have attached thereto a sensor head.

21. The frame of claim 20, and further comprising a fourth mounting pin extending from the body and disposed in spaced, nonlinear, parallel relationship to said at least three mounting pins.

22. The frame of claim 20, wherein free ends of the mounting pins define sensor head reference surfaces, the reference surfaces substantially residing in a single plane.

23. The frame of claim 20, wherein the body is a flat plate.

24. The frame of claim 20, wherein the body is concave in the first direction.

25. A method for aligning a load bearing wheel of a multiwheeled vehicle, comprising the steps of:
removing the wheel from a wheel hub;
providing a rigid support member which will exhibit substantially no deformation when that portion of the weight of the vehicle normally borne by the removed wheel is placed on the rigid support member;
defining at least one support member reference surface on the rigid support member;
attaching the rigid support member to the wheel hub;
registering, at a site of registration, at least one sensor head frame reference surface of a sensor head frame with said at least one support member reference surface; and
affixing the sensor head frame to the rigid support member at a location spaced from the site of registration of the sensor head frame reference surface and the support member, so as not to displace the sensor head relative to the rigid support member.

26. A method for performing a wheelless alignment on a multiwheeled vehicle, at least one wheel of the vehicle supporting a portion of the weight of the vehicle and being removable from a wheel hub, the method comprising the steps of:
providing a rigid support member that, when bearing said portion of the weight of the vehicle, will undergo substantially no deflection;
providing at least three support member reference surfaces on the rigid support member to be spaced in nonlinear relation to each other;
removing a wheel of the vehicle from a wheel hub thereof;
mounting the rigid support member to the wheel hub so as to receive said portion of the weight of the vehicle;
matably registering at least three sensor head frame reference surfaces of a sensor head frame with respective ones of said at least three support member reference surfaces; and
affixing the sensor head frame to the rigid support member without substantially deflecting the position of the sensor head.

27. The method of claim 26, and further comprising the steps of:
providing, as the sensor frame reference surfaces, the free ends of a plurality of pins of the sensor head frame;
inserting the pins into respective bores formed in the rigid support member, the bores terminating in the rigid member reference surfaces;
for each pin, contacting a convex surface of a clamping screw with an inclined surface formed on the pin so as to be spaced from the free end thereof; and
responsive to said step of contacting, urging the free end of the pin against a respective rigid member reference surface.

28. The method of claim 26, and further including the step of affixing the rigid support member to the wheel hub using an adapter plate.

29. The method of claim 26, and further including the step of supporting the rigid support member and said portion of the weight of the vehicle on a turntable.
